(19) United States
(12) Patent Application Publication
(10) Pub. No.: US 2026/0356641 A1
(43) Pub. Date: Nov. 12, 2026

(54) UNMANNED FORKLIFT DEVICE FOR CONSTRUCTION AND OPERATING METHOD THEREOF

(71) Applicant: Seoul Dynamics, Seongnam-si (KR)

(72) Inventors: Geosong LEE, Seongnam-si (KR); Yongseung LEE, Seongnam-si (KR); Seunghan CHUNG, Seongnam-si (KR); Gihyuk CHO, Seongnam-si (KR); Sunghoon KANG, Seongnam-si (KR)

(21) Appl. No.: 19/671,054

(22) Filed: May 7, 2026

(30) Foreign Application Priority Data
May 7, 2025 (KR) 10-2025-0059237
Apr. 30, 2026 (KR) 10-2026-0079153

(51) Int. Cl. B66F 9/06; B66F 9/075; B66F 9/08; B66F 9/10; G05D 1/43; G05D 105/28; G05D 107/70

(52) U.S. Cl. CPC B66F 9/063; B66F 9/0755; B66F 9/07568; B66F 9/082; B66F 9/10; G05D 1/43; G05D 2105/28; G05D 2107/70

(57) ABSTRACT

An unmanned forklift device for transporting a heavy load may include a body including a vehicle-body frame, a fork disposed in front of the body and configured to support the heavy load, a lift module configured to raise and lower the fork, a fork movement module configured to move the fork between a front working position of the body and an upper portion or stowed position of the body, and a controller configured to control the lift module and the fork movement module. The controller may be configured to move the fork to the stowed position while the fork is raised to or above a predetermined height, thereby reducing a forward protrusion length of the fork from the vehicle body.

### CROSS-REFERENCE TO RELATED APPLICATIONS

This application claims priority to and the benefit of Korean Patent Application No. 10-2026-0079153, filed on Apr. 30, 2026, in the Korean Intellectual Property Office, which claims priority to Korean Patent Application No. 10-2025-0059237, filed on May 7, 2025, in the Korean Intellectual Property Office, the entire contents of each of which are incorporated herein by reference.

### TECHNICAL FIELD

The present disclosure relates to an unmanned forklift device and an operating method thereof for transporting heavy loads at a construction site or in an industrial site comparable thereto.

More particularly, the present disclosure relates to an unmanned forklift device and an operating method thereof in which a fork is moved to an upper portion of a vehicle body or to a storage region surrounded by the vehicle body so that travel in a narrow space is possible, and in which a plurality of steering modes may be selected or performed in parallel according to driving circumstances.

### BACKGROUND

Forklifts are widely used as essential equipment for transporting and stacking heavy loads in various industrial sites, such as logistics warehouses, ports, and manufacturing plants. Recently, with advances in autonomous driving technology and control technology, demand has increased for unmanned forklifts, also referred to as automated guided forklifts (AGFs), that can travel along a route and handle cargo without direct operation by a worker.

Construction sites are known as a field in which applying unmanned forklifts is technically difficult because space restrictions such as narrow passages, ramps, and cargo hoists are complex, the weight and shape of transported cargo vary, and ground conditions are uneven. Nevertheless, due to labor shortages at construction sites and increasingly strict industrial safety regulations, research and development are being actively conducted on unmanned forklift devices that can be applied to construction sites.

### SUMMARY

Conventional unmanned forklifts have limited maneuverability in narrow spaces due to structural characteristics of their steering structures and driving methods. In particular, in an environment such as a narrow passage or a right-angle intersection at a construction site, turning may not be smooth, or a large lateral force may be applied to a driving wheel during steering, thereby increasing tire wear and energy consumption.

In addition, when a heavy load is carried, steering responsiveness may decrease, or vehicle-body stability may decrease due to a load acting on a steering drive system. Further, conventional unmanned forklifts generally travel with a fork protruding forward from the vehicle body, and therefore have a limitation in that it is difficult to enter a narrow space having a restricted front space, such as the inside of a cargo hoist.

Based on the foregoing, the present disclosure provides an unmanned forklift device and an operating method thereof that can adaptively select a steering mode according to driving circumstances, including driving speed, loaded weight, and path curvature, and that can enter a narrow space by storing the fork inside the vehicle body.

An unmanned forklift device for transporting a heavy load according to one embodiment of the present disclosure may include a body including a vehicle-body frame, a fork disposed in front of the body and supporting the heavy load, a lift module that raises and lowers the fork, a fork movement module that moves the fork between a front working position of the body and an upper portion or stowed position of the body, and a controller that controls the lift module and the fork movement module. The controller may be configured to move the fork to the stowed position while the fork is raised to or above a predetermined height, thereby reducing a forward protrusion length of the fork from the vehicle body.

In one embodiment, the fork movement module may include a linear guide disposed between a fork carriage and the vehicle-body frame and a movement actuator that moves the fork in a front-rear direction of the vehicle body.

In one embodiment, the controller may be configured to operate the fork movement module only when the fork has been raised to or above a preset target height.

In one embodiment, the controller may be configured to move the fork to the stowed position only when a loading state of the fork or a center of gravity of a load satisfies a preset condition.

In one embodiment, the unmanned forklift device may further include a locking mechanism that fixes the fork so that the fork remains disposed in the stowed position.

In one embodiment, the controller may be configured to activate a narrow-space driving mode while the fork is disposed in the stowed position.

In one embodiment, the unmanned forklift device may be configured to have outer dimensions that allow loading into a cargo hoist or other lifting equipment.

An unmanned forklift device according to one embodiment of the present disclosure may include a plurality of driving wheels, a plurality of travel motors that respectively provide driving force to the plurality of driving wheels, a mechanical steering mechanism that changes a steering angle of at least some of the plurality of driving wheels, and a controller that controls the plurality of travel motors and the mechanical steering mechanism. The controller may be configured to selectively perform at least one of a first steering mode using the mechanical steering mechanism, a second steering mode using differential control of the plurality of travel motors, and a third steering mode in which the first steering mode and the second steering mode are performed together.

In one embodiment, the mechanical steering mechanism may include a pair of knuckles respectively coupled to a pair of steering wheels, a tie rod connecting the pair of knuckles, and a steering actuator that displaces the tie rod.

In one embodiment, the mechanical steering mechanism may be configured so that, during turning, a steering angle of an inner steering wheel is greater than a steering angle of an outer steering wheel.

In one embodiment, in the second steering mode, the controller may turn the vehicle body by controlling a rotation speed or a rotation direction of a left driving-wheel group and a right driving-wheel group differently from each other.

In one embodiment, in the third steering mode, the controller may simultaneously perform steering by the mechanical steering mechanism and differential control of the plurality of travel motors, thereby implementing a turning radius smaller than when the first steering mode alone is performed.

In one embodiment, the controller may be configured to select one of the first steering mode, the second steering mode, and the third steering mode based on at least one of driving speed, loaded weight, path curvature, obstacle information, and surrounding-environment information.

In one embodiment, the controller may be configured to preferentially select the first steering mode when the driving speed exceeds a preset speed threshold.

In one embodiment, the controller may be configured to preferentially select the first steering mode when the loaded weight exceeds a preset load threshold.

In one embodiment, the controller may be configured to select the third steering mode when the path curvature or a target turning radius is equal to or smaller than a preset reference.

In one embodiment, the controller may be configured to switch to the second steering mode and perform a pivot turn or a sharp turn when a separation distance from an obstacle is equal to or smaller than a preset proximity threshold.

In one embodiment, the controller may perform ramping control or hysteresis control so that a control amount is changed gradually when a steering mode is switched.

In one embodiment, the plurality of driving wheels may include a pair of front wheels respectively disposed on left and right sides of the front of the body, and a pair of rear wheels respectively disposed on left and right sides of the rear of the body.

In one embodiment, the mechanical steering mechanism may be a rear-wheel steering mechanism connected to the rear wheels.

In one embodiment, the unmanned forklift device may further include an attitude sensor that detects an inclination of the vehicle body, and the controller may be configured to correct an inclination of a mast or a fork support based on inclination information obtained from the attitude sensor.

In one embodiment, the unmanned forklift device may further include a tilting module that adjusts an inclination of the mast or the lift module.

An operating method of an unmanned forklift for transporting a heavy load according to one embodiment may include confirming whether a load is loaded on a fork, raising or lowering the fork, moving the fork from a front working position of a vehicle body to an upper portion or stowed position of the vehicle body, traveling while the fork is disposed in the stowed position, and, at a destination, returning the fork forward and unloading the load.

In one embodiment, the traveling step may include selecting one of mechanical steering, differential-drive steering, and composite steering based on at least one of driving speed, loaded weight, path curvature, obstacle information, and surrounding-environment information.

In one embodiment, the method may include, based on the obstacle information, performing a pivot turn or a sharp turn when a separation distance from an obstacle is equal to or smaller than a preset reference.

Embodiments of the present disclosure provide an effect in which high steering precision and energy efficiency can be achieved at the same time in various driving environments by adaptively selecting an optimal steering mode based on a plurality of driving parameters including driving speed, loaded weight, and path curvature.

In addition, by reducing an actual forward protrusion length of the unmanned forklift device, travel inside a cargo hoist, in narrow passages, and between floors, which were conventionally difficult or impossible to enter, becomes possible.

Effects obtainable from the present disclosure are not limited to the effects described in connection with the various embodiments, and other effects not explicitly mentioned will be clearly understood by a person having ordinary skill in the art from the following description.

### BRIEF DESCRIPTION OF THE DRAWINGS

FIG. 1 is a perspective view showing an overall configuration of an unmanned forklift device 100 according to one embodiment.

FIG. 2 is a block diagram showing a configuration of an unmanned forklift device according to one embodiment.

FIG. 3 illustrates a lower structure of an unmanned forklift device according to one embodiment.

FIG. 4 illustrates a fork movement operation flow of an unmanned forklift device according to one embodiment.

FIG. 5 is a flowchart illustrating an adaptive steering mode selection method of an unmanned forklift device according to one embodiment.

FIG. 6 is a flowchart illustrating a steering mode switching method upon obstacle detection by an unmanned forklift device according to one embodiment.

FIG. 7 is a flowchart illustrating a fork loading and narrow-space driving method of an unmanned forklift device according to one embodiment.

In connection with the description of the drawings, the same or similar reference numerals may be used for the same or similar components.

### DETAILED DESCRIPTION OF EMBODIMENTS

Hereinafter, embodiments of the present disclosure will be described in detail with reference to the drawings so that a person having ordinary skill in the art to which the present disclosure pertains can readily practice the embodiments. However, the present disclosure may be implemented in many different forms and is not limited to the embodiments described herein. In connection with the description of the drawings, the same or similar reference numerals may be used for the same or similar components. In addition, in the drawings and related description, descriptions of well-known functions and configurations may be omitted for clarity and conciseness.

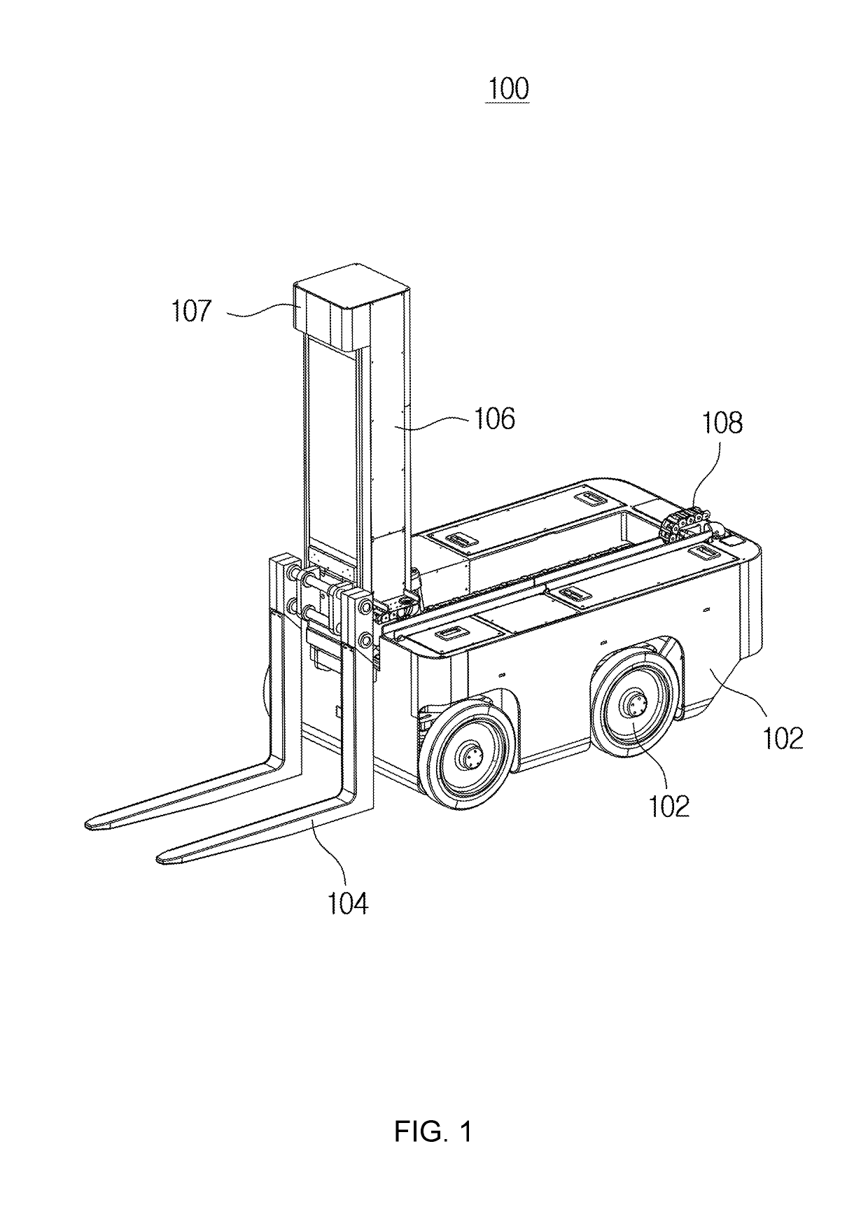

FIG. 1 is a perspective view showing an overall configuration of an unmanned forklift device 100 according to one embodiment of the present invention.

In one embodiment, the unmanned forklift device 100 may include an autonomous or remotely controlled transportation device for transporting heavy loads without an operator at a construction site.

In one embodiment, the unmanned forklift device 100 may include a body 102, a fork 104, a lift module 106, a mast 107, a fork movement module 108, and a plurality of driving wheels 302.

In one embodiment, the body 102 may include a structure forming a vehicle-body frame of the unmanned forklift device 100.

In one embodiment, the body 102 may include a space therein for accommodating a battery, a controller, and various electrical components.

In one embodiment, the body 102 may be formed as a metal frame having a rectangular parallelepiped shape.

In one embodiment, an upper surface of the body 102 may be formed flat so that, when the fork 104 moves into an internal region together with a load, the load may be accommodated.

In one embodiment, the mast 107 and the fork 104 may be disposed at a front side of the body 102.

In one embodiment, the plurality of driving wheels 302 may be mounted to a lower portion of the body 102.

In one embodiment, the body 102 may be designed to have a size that can be loaded into a cargo hoist used at a construction site. Accordingly, vertical movement of the unmanned forklift device 100 between floors of a building may be made possible.

In one embodiment, outer dimensions of the body 102 may be set within a range that can be accommodated in an internal loading space of a cargo hoist.

In one embodiment, the fork 104 may include a configuration for supporting and transporting a heavy load.

In one embodiment, the fork 104 may be disposed in front of the body 102.

In one embodiment, the fork 104 may include a pair of fork arms.

In one embodiment, each fork arm may extend in a horizontal direction and may be configured to support a lower portion of a heavy load.

In one embodiment, the fork 104 may be configured to be movable in a vertical direction by the lift module 106.

In one embodiment, the fork 104 may be configured to be movable in a horizontal direction by the fork movement module 108.

In one embodiment, after being raised in the vertical direction while carrying a heavy load, the fork 104 may be moved along the front-rear direction of the vehicle body to a rear-side stowed position and disposed at an upper portion of the vehicle body or in a storage region surrounded by the vehicle body.

In one embodiment, because the fork 104 is disposed at the upper portion of the vehicle body or in the storage region surrounded by the vehicle body, a forward protrusion length of the fork 104 can be substantially reduced or minimized, thereby enabling travel in a narrow space.

In one embodiment, an appropriate payload of the unmanned forklift device 100 may be 2 tons, and the unmanned forklift device 100 may be configured to allow a load of up to 10 tons for a short time.

In one embodiment, the mast 107 may include a guide structure that guides the fork 104 in a vertical direction.

In one embodiment, the mast 107 may be installed vertically at a front side of the body 102.

In one embodiment, the mast 107 may include a rail structure extending in the vertical direction.

In one embodiment, the fork 104 may be raised and lowered along rails of the mast 107.

In one embodiment, the mast 107 is a main structure that determines a forklifting height of the unmanned forklift device 100, and its length may be set according to requirements for a vertical transport height of a heavy load.

In one embodiment, the lift module 106 may include a drive mechanism that raises and lowers the fork 104 along the mast 107 in the vertical direction.

In one embodiment, the lift module 106 may include a chain drive unit and a lifting motor.

In one embodiment, the chain drive unit may be operated by driving the lifting motor, and the fork 104 may be raised or lowered in the vertical direction along the rails of the mast 107.

In one embodiment, a height sensor may be installed in the lift module 106.

In one embodiment, the height sensor may detect a current height of the fork 104 in real time.

In one embodiment, the controller may precisely control a lifting position of the fork 104 based on an output of the height sensor.

In one embodiment, the fork movement module 108 may include a drive mechanism for moving the fork 104 raised by the lift module 106 along the front-rear direction of the vehicle body to the rear-side stowed position.

In one embodiment, the fork movement module 108 may include a linear guide installed between a fork carriage and the vehicle-body frame, and a fork movement motor.

In one embodiment, by driving the fork movement motor, the fork carriage may move along the linear guide in the front-rear direction of the vehicle body. Accordingly, after the fork 104 is raised to a predetermined height by the lift module 106 while a heavy load is loaded on the fork 104, the fork 104 may be moved by the fork movement module 108 along the front-rear direction of the vehicle body to the rear-side stowed position, thereby enabling the heavy load to be disposed at an upper portion of the vehicle body or in a storage region surrounded by the vehicle body. Therefore, structural limitations caused by the fork 104 can be overcome even in a narrow space, and travel becomes possible.

In one embodiment, the plurality of driving wheels 302 may be mounted to a lower portion of the body 102 and may provide driving force for travel of the unmanned forklift device 100.

In one embodiment, the plurality of driving wheels 302 may include a pair of front wheels respectively disposed on left and right sides of the front of the body 102 and a pair of rear wheels respectively disposed on left and right sides of the rear of the body 102, thereby forming a total of four driving wheels.

In one embodiment, an independent travel motor may be individually connected to each of the plurality of driving wheels 302, thereby providing independent rotational driving force to each driving wheel.

In one embodiment, it is possible to independently control a rotational speed and a rotational direction of each driving wheel 302, and this is a core configuration enabling implementation of skid steering and composite steering described below.

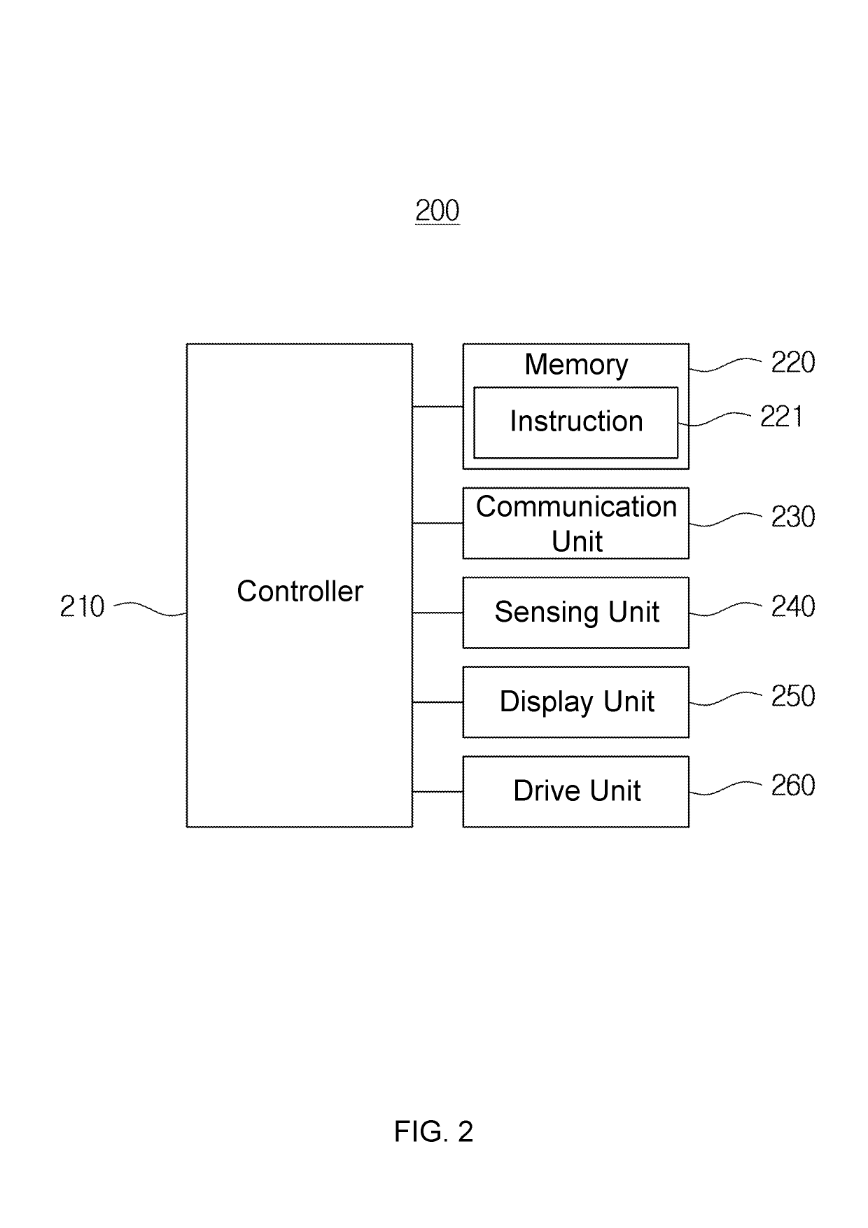

FIG. 2 illustrates a block configuration of an unmanned forklift device according to one embodiment.

According to one embodiment, the unmanned forklift device 110 may include a controller 210, a memory 220, a communication unit 230, a sensing unit 240, a display unit 250, and a drive unit 260.

According to one embodiment, the memory 220 may be a storage medium used by the unmanned forklift device 110 and may store data such as at least one instruction 221 corresponding to at least one program or setting information. The program may include an operating system (OS) program and various application programs.

In one embodiment, the memory 220 may store data received from an external electronic device located adjacent to the unmanned forklift device 110, such as another unmanned forklift device. For example, the data received from the external electronic device may include information regarding a work module, information regarding a work environment, and the like.

In one embodiment, the memory 220 may include at least one type of storage medium selected from a flash memory type, a hard disk type, a multimedia card micro type, a card-type memory such as an SD or XD memory, random access memory (RAM), static random access memory (SRAM), read-only memory (ROM), electrically erasable programmable ROM (EEPROM), programmable ROM (PROM), magnetic memory, magnetic disk, and optical disk.

According to one embodiment, the communication unit 230 may provide a wired or wireless communication interface that enables communication with an external device, such as another vehicle, a control device, or a relay device.

In one embodiment, the communication unit 230 may include at least one of a wireless local area network (LAN) communication unit and a short-range wireless communication unit. The wireless LAN communication unit may include, for example, Wi-Fi and may support a wireless LAN standard (IEEE 802.11x) of the Institute of Electrical and Electronics Engineers (IEEE).

In one embodiment, the communication unit 230 may be wirelessly connected to an access point (AP) under control of the controller 210. The AP may include a device that allows devices to be connected using standards relating to Wi-Fi in a computer network. For example, a relay device 130 may perform functions of an AP.

In one embodiment, the communication unit 230 may perform short-range wireless communication with an external device under control of the controller 210. Short-range communication may include Bluetooth, Bluetooth Low Energy, infrared communication (IrDA), ultra-wideband (UWB), near field communication (NFC), and the like. The external device may include a control device, another unmanned forklift device, a relay device, and a user device such as a smartphone or tablet PC.

In one embodiment, the controller 210 may transmit data regarding travel of the unmanned forklift device 110 to a control device 130 through the communication unit 230. Data regarding travel of the unmanned forklift device 110 may include image data acquired through a camera of the unmanned forklift device 110, a speed of the unmanned forklift device 110, and information regarding a steering state.

In one embodiment, the controller 210 may transmit image data acquired during a predetermined cycle to the control device 130 through the communication unit 230. For example, the controller 210 may transmit data regarding a plurality of frames acquired at 30 ms intervals to the control device 130 through the communication unit 230.

In one embodiment, the controller 210 may transmit image data acquired through the camera to the control device 130 in units of frames through the communication unit 230. For example, the unmanned forklift device 110 may transmit each acquired frame to the control device 130.

In one embodiment, the controller 210 may transmit image data to the control device 130 through the communication unit 230 in response to identifying a predetermined event. For example, when the controller 210 determines, based on a driving environment of the unmanned forklift device 110 such as slope, position, or traffic state, and based on user input, that remote control of the unmanned forklift device 110 is required, the controller 210 may transmit image data to the control device 130 through the communication unit 230.

According to one embodiment, the controller 210 may execute at least one instruction 221 stored in the memory 220 to perform operations or data processing relating to control and/or communication of at least one other component of the unmanned forklift device 110.

In one embodiment, the controller 210 may include at least one of a central processing unit (CPU), graphics processing unit (GPU), microcontroller unit (MCU), sensor hub, supplementary processor, communication processor, application processor, application-specific integrated circuit (ASIC), and field-programmable gate array (FPGA), and may have a plurality of cores.

In one embodiment, the controller 210 may, for example, execute software to control at least one other component of the unmanned forklift device 110 connected to the controller 210, such as a hardware or software component, and may perform various data processing or operations.

According to one embodiment, as at least a part of data processing or operations, the controller 210 may store commands or data received from another component in volatile memory, process the commands or data stored in the volatile memory, and store result data in nonvolatile memory.

According to one embodiment, the controller 210 may include a main controller, such as a central processing unit or an application controller, or an auxiliary controller that can operate independently of or together with the main controller, such as a graphics processing unit, neural processing unit (NPU), image signal controller, sensor hub controller, or communication controller. For example, when the unmanned forklift device 110 includes a main controller and an auxiliary controller, the auxiliary controller may be configured to use less power than the main controller or to be specialized for a designated function. The auxiliary controller may be implemented separately from, or as a part of, the main controller.

In one embodiment, the display unit 250 may display operation state information, warning information, loading-state information, or remote-control information of the unmanned forklift device 110.

In one embodiment, the sensing unit 240 may include various types of sensors for detecting objects adjacent to the unmanned forklift device 110 and identifying a state of the unmanned forklift device 110. For example, the unmanned forklift device 110 may include one or more cameras, a LiDAR sensor, an IMU sensor, a load sensor, a proximity sensor, and the like.

In one embodiment, the unmanned forklift device 110 may acquire data regarding images or video of a surrounding environment of the unmanned forklift device 110 through a camera. For example, the unmanned forklift device 110 may analyze an image of the surrounding environment acquired through the camera, identify an object adjacent to the unmanned forklift device 110, such as a person, another vehicle, a work module, or a trailer, and generate information regarding the work environment of the unmanned forklift device 110 based on information regarding the identified object. For example, the unmanned forklift device 110 may transmit a travel image acquired through the camera to a control device, and the control device may analyze the travel image and transmit a signal for remote control of the unmanned forklift device.

In one embodiment, the unmanned forklift device 110 may identify an object close to the unmanned forklift device 110 through a proximity sensor. For example, the unmanned forklift device 110 may detect the presence of an object, such as another vehicle, pedestrian, animal, or article, located around the unmanned forklift device 110 through the proximity sensor. The unmanned forklift device 110 may identify a distance between the unmanned forklift device 110 and the surrounding object, thereby performing collision avoidance, lane changes, work operations, and the like. The unmanned forklift device 110 may identify a speed and direction of the surrounding object through the proximity sensor and may generate a three-dimensional map of the environment around the unmanned forklift device 110 based on data acquired from the proximity sensor and data acquired from other sensors of the sensing unit 240.

In one embodiment, the unmanned forklift device 110 may generate information regarding the surrounding environment of the unmanned forklift device 110 through a light detection and ranging (LiDAR) sensor. For example, the unmanned forklift device 110 may identify distances and positions of surrounding objects and the unmanned forklift device 110 through the LiDAR sensor and may generate three-dimensional map information based on data acquired from other sensors. In addition, the unmanned forklift device 110 may identify and classify surrounding objects through the LiDAR sensor and may track speeds and movements of the surrounding objects. Further, the unmanned forklift device 110 may accurately recognize a driving and working environment, such as lanes, road boundaries, and obstacles, around the unmanned forklift device 110 through the LiDAR sensor.

In one embodiment, the unmanned forklift device 110 may acquire data regarding movement and direction of the unmanned forklift device 110 through an inertial measurement unit (IMU) sensor. The unmanned forklift device 110 may acquire information regarding linear acceleration, angular velocity, and magnetic field of a work module using the IMU sensor including an accelerometer, a gyroscope, or a magnetometer. For example, the unmanned forklift device 110 may acquire information regarding a change in speed of the unmanned forklift device 110, such as acceleration or deceleration, through the IMU sensor. The unmanned forklift device 110 may acquire information regarding angular velocity of the unmanned forklift device 110, such as a change in vehicle direction, rotation, or inclination, through the IMU sensor. The unmanned forklift device 110 may generate information regarding a current pose and inclination of the unmanned forklift device 110 based on acceleration and angular-velocity information acquired through the IMU sensor. The IMU sensor may be used together with a global positioning system (GPS), not shown.

In one embodiment, the drive unit 260 may include configurations for moving the unmanned forklift device 110 and controlling a work module. Through the drive unit 260, the unmanned forklift device 110 may control travel, direction adjustment, speed adjustment, and a specific operation of the work module.

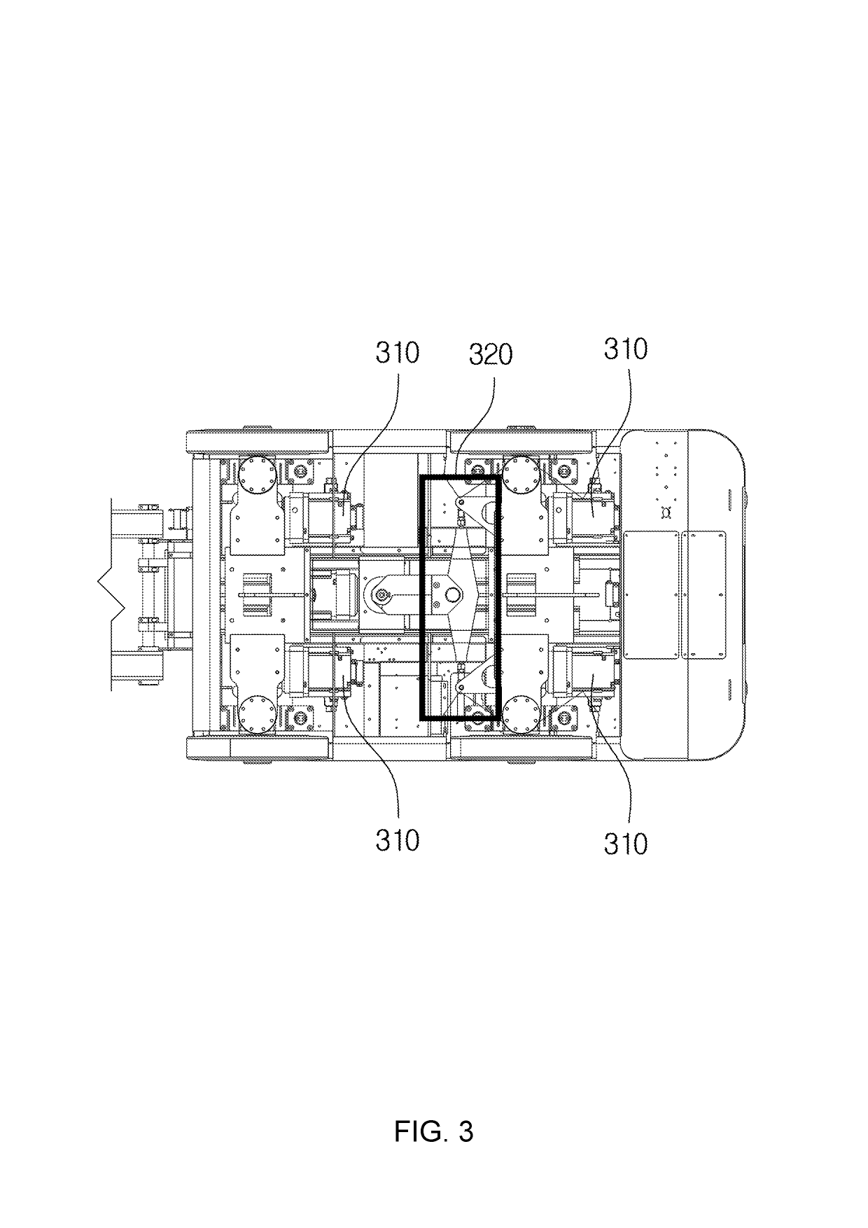

FIG. 3 is a bottom view showing a lower structure of the unmanned forklift device 100 according to one embodiment of the present invention.

In one embodiment, a plurality of travel motors 310 and a steering unit 320 may be disposed on a lower surface of the unmanned forklift device 100.

In one embodiment, the plurality of travel motors 310 may be respectively disposed near four corners of the unmanned forklift device 100. Each of the plurality of travel motors 310 may be configured to transmit rotational driving force to a corresponding driving wheel 302.

In one embodiment, one travel motor 310 may be disposed at each of a front-left position, a front-right position, a rear-left position, and a rear-right position.

In one embodiment, each travel motor 310 may be connected directly to the corresponding driving wheel 302 or through a reducer.

In one embodiment, the rotational speed and rotational direction of each travel motor 310 may be individually controlled by a control signal of the controller 210.

In one embodiment, an encoder may be installed at each travel motor 310. The encoder may be configured to measure, in real time, an actual rotational speed of each driving wheel 302.

In one embodiment, the controller 210 may perform closed-loop speed control for each travel motor 310 based on an output of the encoder.

In one embodiment, by configuring an independent travel motor 310 to be connected to each driving wheel 302, a rotational speed between a left driving-wheel group and a right driving-wheel group may be differentially controlled.

In one embodiment, the left driving-wheel group may include a left front wheel and a left rear wheel, and the right driving-wheel group may include a right front wheel and a right rear wheel.

In one embodiment, the differential speed control configuration may correspond to an essential configuration for implementing skid steering described below.

In one embodiment, the steering unit 320 may include a mechanism for performing rear-wheel steering of the unmanned forklift device 100.

In one embodiment, the steering unit 320 may be disposed in a central region of the bottom view.

In one embodiment, the steering unit 320 may include a rear-wheel steering mechanism based on an Ackermann steering method.

In one embodiment, the rear-wheel steering mechanism may include a pair of knuckles, kingpins formed at the respective knuckles, a tie rod mechanically connecting the pair of knuckles, and a steering actuator that displaces the tie rod in a vehicle-width direction.

In one embodiment, the pair of knuckles may be respectively coupled to a rear-left driving wheel and a rear-right driving wheel. Each knuckle may be mounted to be rotatable about a corresponding kingpin.

In one embodiment, the tie rod may include a link member mechanically connecting a left knuckle and a right knuckle. The tie rod may be configured to extend in a vehicle-width direction, that is, in a left-right direction.

In one embodiment, the steering actuator may include an electric motor or a hydraulic cylinder. The steering actuator may be configured to provide a driving force that displaces the tie rod in the vehicle-width direction.

In one embodiment, when the tie rod is displaced to one side by the steering actuator, the pair of knuckles connected by the tie rod may rotate about their respective kingpins. Accordingly, the pair of rear wheels may be turned to a predetermined steering angle.

In one embodiment, according to Ackermann geometry, a steering angle of a rear wheel located on an inner side of a turn may be set to be greater than a steering angle of a rear wheel located on an outer side of the turn. As a result, during turning, extension lines of rotation axes of all driving wheels may intersect at one common instantaneous center of rotation. By setting the common instantaneous center of rotation, lateral slip of the tires can be minimized, and stable turning characteristics can be ensured.

In one embodiment, the steering unit 320 may be configured to perform rear-wheel steering using an Ackermann steering method. Because an independent travel motor 310 is connected to each driving wheel 302, skid steering by differential speed control of the left and right driving-wheel groups can also be performed even without Ackermann steering.

In one embodiment, skid steering and Ackermann steering may be used simultaneously, thereby implementing a very small turning radius even when a high-weight load is carried.

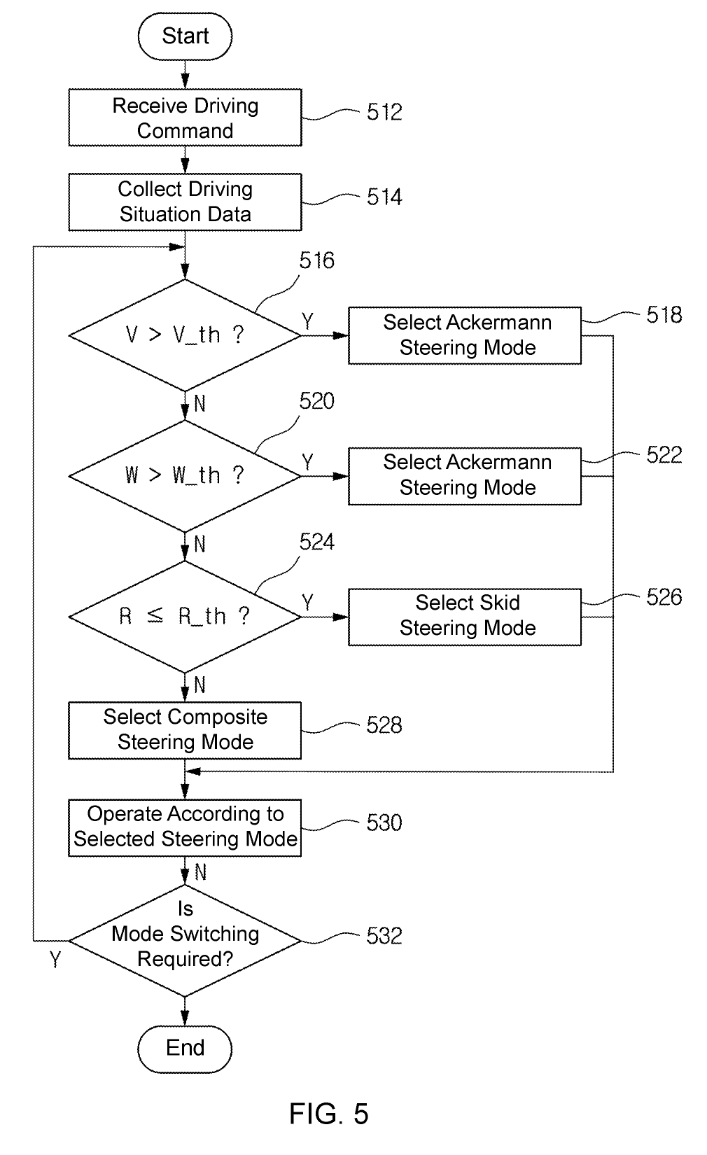

In one embodiment, the unmanned forklift device 100 may be configured to selectively perform an Ackermann steering mode, a skid steering mode, and a composite steering mode. Detailed operation of each steering mode may be described with reference to FIGS. 5-7 below.

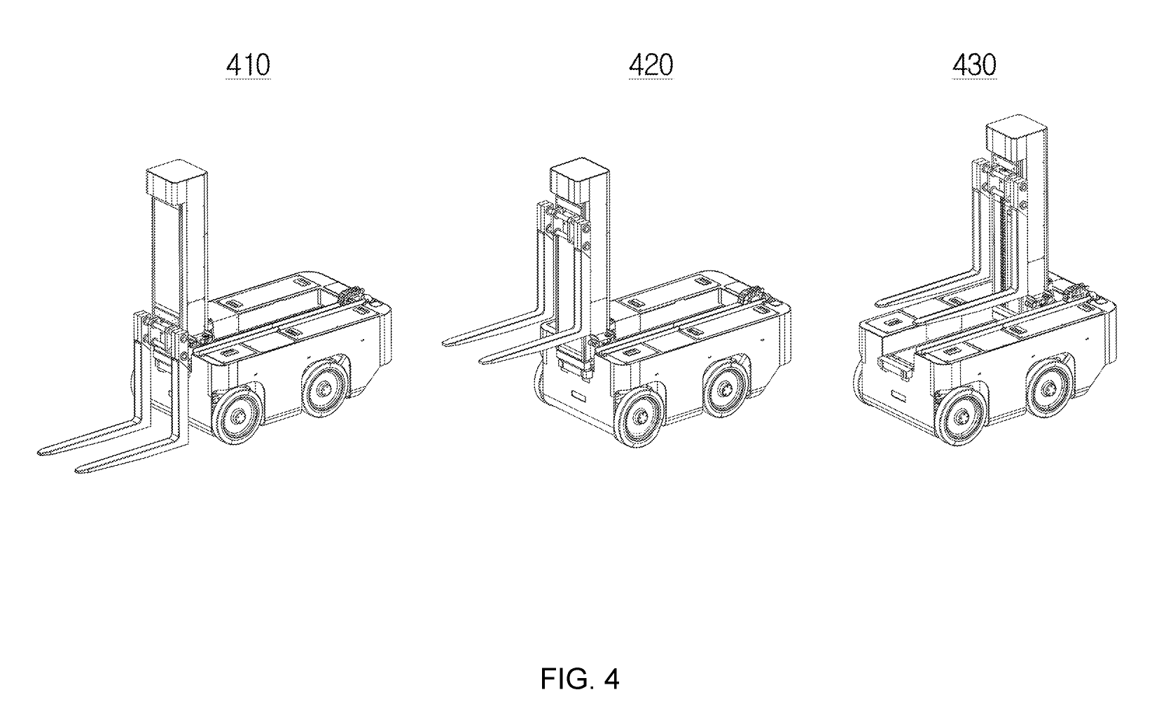

FIG. 4 is an operation state diagram showing a fork movement operation of the unmanned forklift device 100 according to one embodiment of the present invention.

In one embodiment, a movement process of the fork 104 may be divided into three operations. The three operations may respectively correspond to a first state 410, a second state 420, and a third state 430.

In one embodiment, the first state 410 may show a state in which the fork 104 is in an initial position. In the initial position, the fork 104 may be disposed in front of the body 102.

In one embodiment, a pair of fork arms may be in a state extending horizontally toward the front.

In one embodiment, the first state 410 is similar to a typical forklift fork arrangement and corresponds to a position in which loading and unloading work for a heavy load is performed.

In one embodiment, in the first state 410, the fork 104 may be located at a low height close to the ground.

In one embodiment, the fork 104 may be in a state in which the fork arms are inserted under a heavy load and support the heavy load.

In one embodiment, in the first state 410, a forward protrusion length of the fork 104 is maximum, and the overall length of the unmanned forklift device 100 is at its longest state.

In one embodiment, the second state 420 may show an intermediate state in which, after the fork 104 is raised in the vertical direction by the lift module 106, movement toward the rear-side stowed position along the front-rear direction of the vehicle body is in progress by the fork movement module 108.

In one embodiment, in the second state 420, the lift module 106 may be driven first so that the fork 104 is raised along the mast 107 to a predetermined height.

In one embodiment, the predetermined height may be set to a minimum height at which the fork 104 reaches a position higher than an upper surface of the body 102 and physical interference with structures of the body 102 does not occur during subsequent horizontal movement.

In one embodiment, after the fork 104 reaches the predetermined height, the fork movement module 108 may be driven. Accordingly, the fork carriage may begin to move horizontally toward the rear of the body 102 along the linear guide.

In one embodiment, the third state 430 may show a state in which horizontal movement of the fork 104 is completed and the fork 104 is disposed at an upper portion of the vehicle body or in a storage region surrounded by the vehicle body.

In one embodiment, in the third state 430, the fork 104 may be located above the body 102. The fork arms of the fork 104 may be in a state in which they do not protrude beyond a front end of the body 102.

In one embodiment, in the third state 430, the forward protrusion length of the fork 104 is reduced or minimized, and the overall length of the unmanned forklift device 100 can be greatly reduced compared with the first state 410.

In one embodiment, in the third state 430, the fork carriage may be fixed at the corresponding position by a predetermined locking mechanism. The locking mechanism may prevent unintended movement of the fork 104 due to vibration or inertial force during travel.

In one embodiment, according to the fork movement operation, the fork 104 is lifted in the vertical direction and then horizontally moved onto the upper portion of the body 102, so that a heavy load may be loaded at the upper portion of the vehicle body or in a storage region surrounded by the vehicle body. Accordingly, structural limitations caused by the fork 104 can be overcome even in a narrow space, and travel becomes possible.

In one embodiment, at a construction site or the like, the unmanned forklift device 100 in a loaded state may be loaded into and operated within a cargo hoist. Accordingly, not only horizontal transport of heavy loads within a floor, but also vertical transport of heavy loads between floors, may be realized. The fork movement operation can expand the application range of an autonomous driving system within a construction site.

FIG. 5 is a flowchart showing an adaptive steering mode selection method of the unmanned forklift device 100 according to one embodiment of the present invention.

In one embodiment, the adaptive steering mode selection method may be configured to select, in real time, an optimal steering mode among an Ackermann steering mode, a skid steering mode, and a composite steering mode according to driving circumstances of the unmanned forklift device 100.

In one embodiment, the adaptive steering mode selection method may be configured to dynamically switch the steering mode in response to a change in circumstances during driving.

According to one embodiment, in operation 512, the unmanned forklift device may receive a driving command and collect driving situation data.

In one embodiment, the driving command may be received through the communication unit 230 from an autonomous driving system or a remote control device.

In one embodiment, the driving command may include destination coordinates, waypoints, driving route data, and priority information.

According to one embodiment, in operation 514, the unmanned forklift device may collect driving situation data.

In one embodiment, the driving situation data may include a current driving speed V, a load weight W of a heavy load loaded on the fork 104, surrounding-environment information received from the sensing unit 240, and curvature radius R information for a forward segment on a driving route.

In one embodiment, the current driving speed V may be determined as an average value of individual wheel speeds calculated from encoders installed at the respective driving wheels 302.

In one embodiment, the loaded weight W may be measured from a load sensor installed at the fork 104 or the lift module 106.

In one embodiment, the unmanned forklift device may begin a sequential determination for selecting a steering mode based on the collected driving situation data.

According to one embodiment, in operation 516, the unmanned forklift device may determine whether the current driving speed V exceeds a preset speed threshold V_th.

In one embodiment, the speed threshold V_th may be set in consideration of a range in which lateral slip generated between the driving wheels and the ground during skid steering does not impair vehicle-body stability.

In one embodiment, the speed threshold V_th may be set within a range of about 3 km/h to 8 km/h. When skid steering is performed in a high-speed driving region, an abrupt speed difference between the left and right driving-wheel groups may cause abnormal tire wear, vehicle-body leaning, or instability of the load. Accordingly, it may be desirable to limit use of skid steering in a high-speed driving region.

In one embodiment, when the unmanned forklift device determines that the current driving speed V exceeds the preset speed threshold V_th, operation 518 may be performed.

In one embodiment, when the unmanned forklift device determines that the current driving speed V does not exceed the preset speed threshold V_th, operation 520 may be performed.

According to one embodiment, in operation 518, when the current driving speed V exceeds the speed threshold V_th, the unmanned forklift device may select the Ackermann steering mode. During high-speed driving, mechanical steering according to Ackermann geometry may be advantageous in terms of vehicle-body stability and steering precision. According to the Ackermann steering method, during turning, all driving wheels are aligned toward a common instantaneous center of rotation, so that lateral slip of the tires can be minimized.

According to one embodiment, in operation 520, when the current driving speed V is equal to or lower than the speed threshold V_th, the unmanned forklift device may determine whether the loaded weight W exceeds a preset load threshold W_th.

In one embodiment, the load threshold W_th may be set in consideration of a range in which an inertial moment generated by a speed difference between the left and right driving-wheel groups during skid steering does not impair load stability.

According to one embodiment, in operation 522, when the loaded weight W exceeds the load threshold W_th, the unmanned forklift device may select the Ackermann steering mode. In a high-load state, gradual and stable direction change by a mechanical steering mechanism may be advantageous in ensuring load safety.

According to one embodiment, in operation 524, when the loaded weight W is equal to or lower than the load threshold W_th, the unmanned forklift device may determine whether a curvature radius R of a forward turning segment is equal to or smaller than a preset curvature threshold R_th.

In one embodiment, the curvature threshold R_th may be set based on a minimum turning radius that can be implemented when only the Ackermann steering mode is performed.

In one embodiment, the curvature threshold R_th may be set to a value corresponding to about 1.2 to 1.5 times a kinematic minimum turning radius determined by a wheelbase, a maximum steering angle, and a vehicle-body width of the unmanned forklift device 100.

According to one embodiment, in operation 526, when the curvature radius R exceeds the curvature threshold R_th, the unmanned forklift device may select the skid steering mode. In a low-speed and low-load state, sufficient steering performance may be secured by skid steering alone in a turning segment having a relatively large curvature radius. In addition, energy consumption of the steering actuator can be reduced.

According to one embodiment, in operation 528, when the curvature radius R is equal to or smaller than the curvature threshold R_th, the unmanned forklift device may select the composite steering mode.

In one embodiment, the composite steering mode may include a mode in which Ackermann steering and skid steering are simultaneously performed. By the composite steering mode, a small turning radius that cannot be achieved by Ackermann steering alone can be implemented.

In one embodiment, in the composite steering mode, mechanical steering by the rear-wheel steering mechanism and differential speed control of the left and right travel motors 310 may be simultaneously performed. Accordingly, smooth route following can be achieved even in a section requiring abrupt direction change.

According to one embodiment, in operation 530, the unmanned forklift device may execute a steering operation by controlling the drive unit 260 according to the selected steering mode.

In one embodiment, in the Ackermann steering mode, the steering actuator may be driven so that the tie rod is displaced.

In one embodiment, in the skid steering mode, rotation speeds of travel motors 310 of the left and right driving-wheel groups may be differentially controlled.

In one embodiment, in the composite steering mode, the Ackermann steering operation and the skid steering operation may be performed simultaneously.

According to one embodiment, in operation 532, the unmanned forklift device may monitor changes in driving situation data in real time during driving. The unmanned forklift device may determine whether switching of the steering mode is necessary.

In one embodiment, when it is determined that steering mode switching is necessary, the method may return to operation 514, and steering mode reselection may be performed based on current driving situation data.

In one embodiment, switching of the steering mode may be performed gradually during a predetermined transition time in order to prevent abrupt changes in a control input. The predetermined transition time may be set, for example, within a range of 0.5 seconds to 2 seconds.

In one embodiment, when mode switching is not necessary, driving may continue while the current steering mode is maintained. When the unmanned forklift device 100 reaches a destination, driving may end.

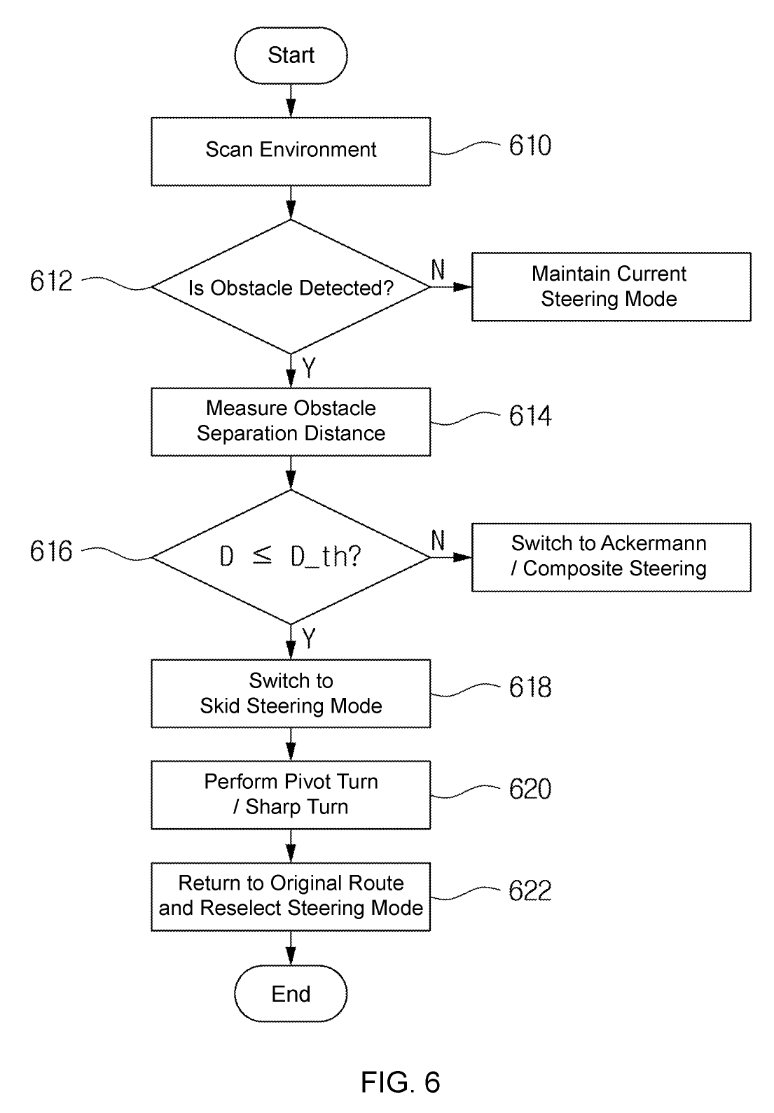

FIG. 6 is a flowchart showing a steering mode switching method when an obstacle is detected by the unmanned forklift device 100 according to one embodiment of the present invention.

In one embodiment, the steering mode switching method upon obstacle detection may be configured so that, when an unexpected obstacle is detected during autonomous driving, the steering mode is rapidly switched to an optimal steering mode based on a separation distance from the obstacle. By the switching, safe and efficient obstacle avoidance can be performed.

According to one embodiment, in operation 610, the unmanned forklift device may perform a scan of a forward environment using the sensing unit 240 during autonomous driving.

In one embodiment, the sensing unit 240 may include at least one of LiDAR, a stereo camera, and an ultrasonic sensor.

In one embodiment, data collected from each sensor may be fusion-processed. Through the fusion processing, a three-dimensional point-cloud map or a two-dimensional occupancy grid map of the forward environment may be generated.

In one embodiment, the environment scan may be continuously performed at a predetermined cycle during driving. The predetermined cycle may be set, for example, within a range of 10 Hz to 50 Hz. In each scanning cycle, an object within a predetermined forward range may be detected. The predetermined range may be set, for example, within a range of 0.5 m to 15 m.

In one embodiment, based on the environment scan result, the unmanned forklift device may determine whether an obstacle exists in front of the driving route. When no obstacle is detected, the unmanned forklift device may maintain the currently performed steering mode and continue the environment scan.

In one embodiment, in a normal driving state with no obstacle, the steering mode selected by the adaptive steering mode selection method described above with reference to FIG. 5 may be maintained.

According to one embodiment, in operation 614, when an obstacle is detected, the unmanned forklift device may measure a separation distance D between the unmanned forklift device 100 and the obstacle.

In one embodiment, the separation distance D may be defined as a shortest distance between the closest point of the obstacle measured by the sensing unit 240 and a front surface of the vehicle body of the unmanned forklift device 100.

In one embodiment, in point-cloud data acquired from the LiDAR sensor, a distance to the nearest point among points within a predetermined forward angular range of the vehicle body may be calculated as the separation distance D. The predetermined angular range may be set, for example, within a range of forward +/-30 degrees.

In one embodiment, the unmanned forklift device may classify the detected object as a static obstacle or a dynamic obstacle by comparison with a previous scanning cycle. A static obstacle may include, for example, a wall or stacked materials. A dynamic obstacle may include, for example, a worker or another moving vehicle.

In one embodiment, in the case of a dynamic obstacle, the unmanned forklift device may predict a moving speed and moving direction of the dynamic obstacle using a Kalman filter.

According to one embodiment, in operation 616, the unmanned forklift device may determine whether the separation distance D is equal to or smaller than a preset proximity threshold D_th.

In one embodiment, the proximity threshold D_th may be determined by adding a safety margin value to a sum of a braking distance based on a current driving speed and a travel distance during a time required for steering mode switching.

In one embodiment, when the separation distance D exceeds the proximity threshold D_th, the unmanned forklift device may determine that there is a sufficient margin relative to the obstacle. In this case, the unmanned forklift device may switch to the Ackermann steering mode or the composite steering mode and may generate and follow a detour route.

In one embodiment, the unmanned forklift device may generate, in real time through a route planning module, a detour route that avoids the obstacle while reaching the original destination.

According to one embodiment, in operation 618, when the separation distance D is equal to or smaller than the proximity threshold D_th, the unmanned forklift device may determine that emergency avoidance is required. In this case, the unmanned forklift device may immediately switch to the skid steering mode.

In one embodiment, because the skid steering mode does not require mechanical operation time of the rear-wheel steering mechanism, an immediate direction change may be possible only by speed control of the travel motors 310. This characteristic may be advantageous in minimizing response time in an emergency avoidance situation for a nearby obstacle.

According to one embodiment, in operation 620, the unmanned forklift device may avoid the obstacle by performing a pivot turn or a sharp turn using skid steering.

In one embodiment, in the case of a pivot turn, the left driving-wheel group and the right driving-wheel group may be rotated in opposite directions. As a result, the vehicle body may rotate in place by a target angle.

In one embodiment, in the case of a sharp turn, a speed of one driving-wheel group may be greatly reduced or stopped, and the opposite driving-wheel group may rotate at high speed. As a result, an abrupt direction change can be performed with a minimum travel distance.

In one embodiment, the unmanned forklift device may determine a turning direction based on a position of the obstacle. The turning direction may be determined as one of a left turn and a right turn. Even during an avoidance operation, environment scanning by the sensing unit 240 may continue, so that the presence of an additional obstacle on the avoidance route can be confirmed.

According to one embodiment, in operation 622, after obstacle avoidance is completed, the unmanned forklift device may generate a return route for returning to the original driving route. The unmanned forklift device may reselect a steering mode suitable for the current driving circumstances.

In one embodiment, the unmanned forklift device may calculate an optimal merging point on the original route based on a current position and heading angle changed by obstacle avoidance. The unmanned forklift device may generate a return route to the merging point.

In one embodiment, the return route may be designed in a smooth curved shape so that abrupt direction changes are minimized, and smooth route merging is possible. The smooth curve may include, for example, a clothoid curve or a Bezier curve.

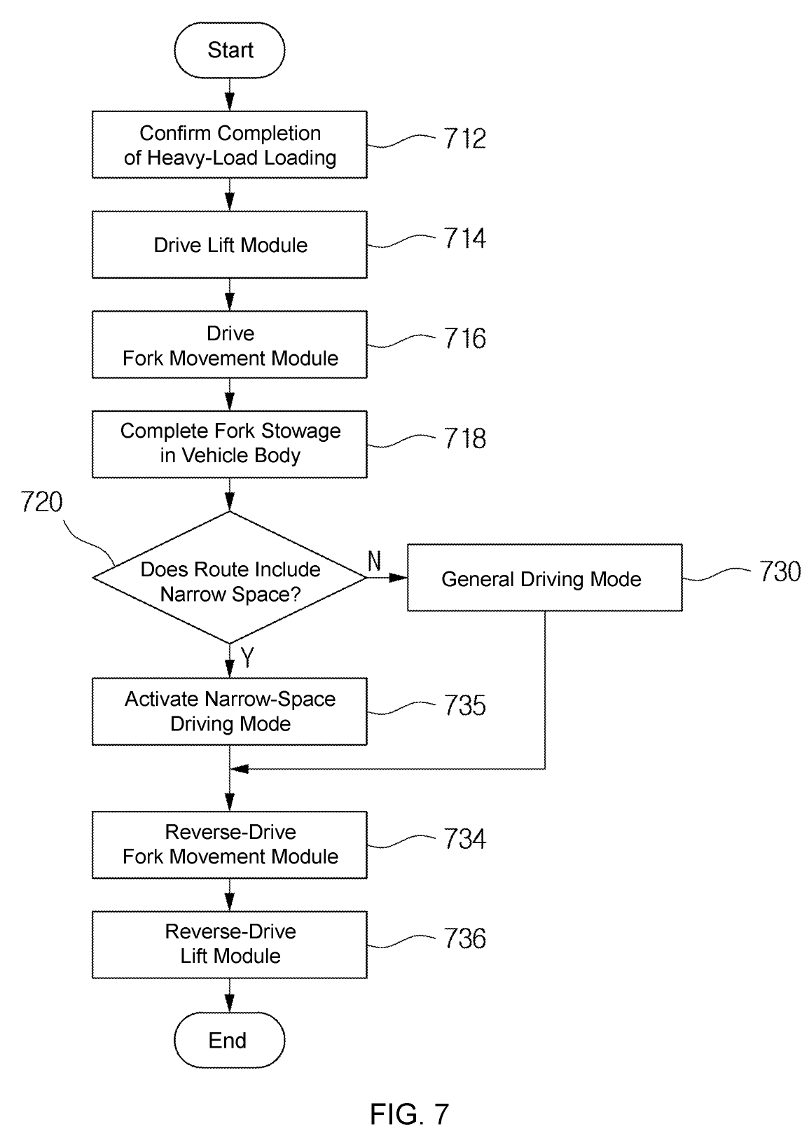

FIG. 7 is a flowchart showing a fork loading and narrow-space driving method of the unmanned forklift device 100 according to one embodiment of the present invention.

In one embodiment, the fork loading and narrow-space driving method may be configured to move a heavy load loaded on the fork 104 to an upper portion of the vehicle body or to a storage region surrounded by the vehicle body so as to reduce the forward protrusion length. Accordingly, driving maneuverability can be improved in a limited-space region, such as a narrow passage at a construction site, inside an elevator, or inside a cargo hoist.

According to one embodiment, in operation 712, the unmanned forklift device may confirm whether loading of a heavy load on the fork 104 is completed.

In one embodiment, loading completion may be determined when a loaded weight measured by a load sensor installed at the fork 104 or the lift module 106 is equal to or greater than a predetermined minimum threshold and maintains a stable state for a predetermined time. The predetermined time may be set, for example, to 2 seconds.

In one embodiment, the unmanned forklift device may calculate a center-of-gravity position of the heavy load from a plurality of measurement points of the load sensor. The unmanned forklift device may confirm whether the center of gravity is located within an allowable range of the fork 104.

In one embodiment, when the center of gravity is outside the allowable range, the unmanned forklift device may generate a loading failure warning through the display unit 250. In this case, progress of subsequent operations may be deferred.

According to one embodiment, in operation 714, the unmanned forklift device may drive the lift module 106 to raise the fork 104 in the vertical direction. The lift module 106 may include the mast 107, a chain drive unit, and a lifting motor. The chain drive unit may be operated by driving the lifting motor, so that the fork 104 is raised in the vertical direction along the mast 107.

In one embodiment, the unmanned forklift device may control a lifting speed of the fork 104 to be inversely proportional to the loaded weight. When the loaded weight is large, the lifting speed may be reduced to ensure stable lifting. When the loaded weight is small, the lifting speed may be increased to improve work efficiency.

In one embodiment, the unmanned forklift device may receive feedback regarding a current height of the fork 104 from a height sensor installed in the lift module 106. The unmanned forklift device may precisely raise the fork 104 to a predetermined target height at which horizontal movement by the fork movement module 108 is possible.

In one embodiment, while the fork 104 is being raised, the unmanned forklift device may monitor an inclination of the vehicle body using an IMU. Accordingly, an effect of a shift of the center of gravity caused by raising the heavy load on vehicle-body stability can be monitored.

According to one embodiment, in operation 716, the unmanned forklift device may drive the fork movement module 108 to move the fork 104 along the front-rear direction of the vehicle body to the rear-side stowed position. The fork movement module 108 may include a linear guide installed between the fork carriage and the vehicle-body frame and a fork movement motor.

In one embodiment, by driving the fork movement motor, the fork carriage may be moved toward the rear of the vehicle body along the linear guide.

In one embodiment, the unmanned forklift device may receive feedback regarding a current position of the fork carriage from a position sensor. The unmanned forklift device may perform precise position control to a target position.

In one embodiment, during horizontal movement, the movement speed may be controlled so that shaking or separation of the load due to abrupt acceleration or deceleration is prevented.

According to one embodiment, in operation 718, disposition of the fork 104 at an upper portion of the vehicle body or in a storage region surrounded by the vehicle body may be completed. The upper portion of the vehicle body or the storage region surrounded by the vehicle body may be defined as a space between the upper surface of the body 102 and a lower surface of the fork 104 and between the front end and rear end of the body 102.

In one embodiment, because the fork 104 is disposed at the upper portion of the vehicle body or in the storage region surrounded by the vehicle body, the forward protrusion length of the fork 104 can be greatly reduced. Accordingly, the overall length of the unmanned forklift device 100 can be reduced.

In one embodiment, the unmanned forklift device may operate a locking mechanism for fixing the fork carriage at the corresponding position.

According to one embodiment, in operation 720, the unmanned forklift device may determine whether the driving route includes a narrow space. Determination of the narrow space may be performed based on passage width information included in driving route data. In addition, determination of the narrow space may be performed based on a width of a drivable region measured in real time by the sensing unit 240.

In one embodiment, when the width of the drivable region is equal to or smaller than a value obtained by adding a predetermined clearance margin to the vehicle-body width of the unmanned forklift device 100, the corresponding segment may be determined as a narrow space. The predetermined clearance margin may be set, for example, within a range of 30% to 50% of the vehicle-body width.

In one embodiment, when it is determined that the driving route does not include a narrow space, in operation 730, the unmanned forklift device may maintain a general driving mode. In this case, steering mode selection according to the adaptive steering mode selection method described above with reference to FIG. 5 may be performed.

In one embodiment, even when the fork 104 is disposed at the upper portion of the vehicle body or in the storage region surrounded by the vehicle body, an optimal steering mode suitable for driving circumstances may be applied in a general driving region.

According to one embodiment, in operation 732, when it is determined that the driving route includes a narrow space, the unmanned forklift device may activate a narrow-space driving mode. In the narrow-space driving mode, the unmanned forklift device may preferentially apply the skid steering mode or the composite steering mode. Accordingly, driving with a minimum turning radius becomes possible.

In one embodiment, the skid steering mode capable of a pivot turn may be useful for direction change at a narrow T-shaped intersection or a dead end.

In one embodiment, the unmanned forklift device may limit an upper limit of driving speed to a predetermined value or less to ensure safety. The predetermined value may be set, for example, within a range of 2 km/h to 3 km/h. In addition, the unmanned forklift device may increase a cycle of environment scanning by the sensing unit 240 to improve obstacle detection capability.

According to one embodiment, in operation 734, after the unmanned forklift device 100 reaches a destination, the unmanned forklift device may drive the fork movement module 108 in a reverse direction to return the fork 104 toward the front of the body 102.

In one embodiment, when returning the fork 104 forward, the unmanned forklift device may first release the locking mechanism of the fork carriage. Thereafter, the fork movement motor may be driven in the reverse direction so that the fork carriage moves forward along the linear guide.

According to one embodiment, in operation 736, the unmanned forklift device may drive the lift module 106 in a reverse direction to lower the fork 104. Accordingly, the heavy load may be unloaded.

In one embodiment, when the fork 104 is lowered, the unmanned forklift device may control a lowering speed based on the loaded weight and a height of an unloading point.

In one embodiment, when it is confirmed by the height sensor that the fork 104 has reached a target unloading height, the unmanned forklift device may stop driving the lift module 106.

In one embodiment, after unloading is completed, the unmanned forklift device 100 may move backward and separate from the heavy load. Alternatively, the unmanned forklift device 100 may switch to a state of waiting for a next work command.

In one embodiment, even during reverse travel, the unmanned forklift device may apply an adaptive steering mode according to driving circumstances and may perform safe and efficient travel.

An unmanned forklift device for transporting a heavy load at a construction site according to one embodiment of the present disclosure may include a body including a vehicle-body frame, a fork disposed in front of the body and configured to support a heavy load, a lift module that raises and lowers the fork in a vertical direction, a fork movement module configured to move the fork raised by the lift module along a front-rear direction of the vehicle body to a rear-side stowed position, a plurality of driving wheels including a pair of front wheels respectively disposed on left and right sides of the front of the body and a pair of rear wheels respectively disposed on left and right sides of the rear of the body, a plurality of travel motors individually connected to the plurality of driving wheels and providing independent rotational driving force to each driving wheel, a rear-wheel steering mechanism including a pair of knuckles rotatably coupled to the pair of rear wheels about kingpins, a tie rod mechanically connecting the pair of knuckles, and a steering actuator that displaces the tie rod, the rear-wheel steering mechanism being configured such that displacement of the tie rod causes the pair of rear wheels to rotate according to Ackermann geometry so that an inner rear wheel has a larger steering angle than an outer rear wheel, and a controller that controls the plurality of travel motors and the rear-wheel steering mechanism. The controller may be configured to selectively perform, according to driving circumstances, at least one of an Ackermann steering mode in which the steering actuator is driven to steer the pair of rear wheels according to Ackermann geometry, a skid steering mode in which rotation speeds of the plurality of travel motors are differentially controlled between a left driving-wheel group and a right driving-wheel group to turn the vehicle body without mechanical steering of the rear-wheel steering mechanism, and a composite steering mode in which the Ackermann steering mode and the skid steering mode are simultaneously performed to reduce a turning radius.

In one embodiment, in the Ackermann steering mode, the controller may drive the steering actuator to displace the tie rod in the vehicle-width direction, and displacement of the tie rod may cause the pair of knuckles to rotate about their respective kingpins so that a steering angle of a rear wheel located on an inner side of a turn is set to be greater than a steering angle of a rear wheel located on an outer side of the turn.

In one embodiment, in the skid steering mode, the controller may control the vehicle body to turn by rotating a travel motor of a left or right driving-wheel group located on the turning-direction side at a relatively low speed or in a reverse direction and rotating a travel motor of the opposite driving-wheel group at a relatively high speed, so that the vehicle body is turned by a speed difference between the left and right driving-wheel groups.

In one embodiment, in the composite steering mode, the controller may simultaneously perform Ackermann steering of the rear wheels by the rear-wheel steering mechanism and differential speed control of the left and right driving-wheel groups by the plurality of travel motors, thereby implementing a turning radius smaller than a turning radius when the Ackermann steering mode alone is performed.

In one embodiment, the controller may be configured to select the skid steering mode or the composite steering mode when a current driving speed of the unmanned forklift is equal to or lower than a preset speed threshold, and to select the Ackermann steering mode when the current driving speed exceeds the speed threshold.

In one embodiment, the controller may be configured to preferentially select the Ackermann steering mode when a load of a heavy load loaded on the fork exceeds a preset load threshold, and to select the skid steering mode or the composite steering mode when the load is equal to or lower than the load threshold.

In one embodiment, the controller may be configured to select the composite steering mode when a curvature radius of a turning segment on a driving route is equal to or smaller than a preset curvature threshold, and to select the Ackermann steering mode when the curvature radius exceeds the curvature threshold.

In one embodiment, the controller may perform steps of collecting driving situation data including driving route information, a current driving speed, loaded-weight information, and surrounding-environment information, selecting one of the Ackermann steering mode, the skid steering mode, and the composite steering mode based on the driving situation data, and controlling the rear-wheel steering mechanism and the plurality of travel motors according to the selected steering mode. The controller may be configured to switch the steering mode in real time in response to a change in the driving situation data during driving.

In one embodiment, the unmanned forklift may further include a sensor module for recognizing a driving route, the sensor module may include at least one of LiDAR, a camera, and an ultrasonic sensor, and the controller may be configured to generate an autonomous driving route based on surrounding-environment information received from the sensor module and to select the steering mode.

In one embodiment, when an obstacle ahead of the driving route is detected by the sensor module, the controller may be configured to switch the currently performed steering mode to another steering mode suitable for obstacle avoidance, and when a separation distance from the obstacle is equal to or smaller than a preset proximity threshold, the controller may switch to the skid steering mode and perform a pivot turn or a sharp turn.

In one embodiment, in the skid steering mode, the controller may be configured to rotate the left driving-wheel group and the right driving-wheel group in opposite directions, so that the unmanned forklift performs a pivot turn about a vehicle-body center point.

In one embodiment, the fork movement module may include a linear guide installed between the fork carriage and the vehicle-body frame and a fork movement motor, and after the fork is raised in the vertical direction by the lift module while carrying a heavy load, the fork may be moved by the fork movement module along the front-rear direction of the vehicle body to the rear-side stowed position and disposed at an upper portion of the vehicle body or in a storage region surrounded by the vehicle body, thereby reducing the forward protrusion length of the fork and enabling travel in a narrow space.

In one embodiment, the controller may activate the narrow-space driving mode while the fork is disposed at the upper portion of the vehicle body or in the storage region surrounded by the vehicle body, and in the narrow-space driving mode, the controller may preferentially apply the skid steering mode or the composite steering mode so as to travel with a minimum turning radius.

In one embodiment, the unmanned forklift may be configured to have a size loadable into a cargo hoist, so that movement between floors of a building is possible.

Electronic devices according to various embodiments disclosed in this document may be devices of various forms. The electronic devices may include, for example, a display device, a portable communication device such as a smartphone, a computer device, a portable multimedia device, a portable medical device, a camera, a wearable device, or a home appliance. An electronic device according to an embodiment of this document is not limited to the above-described devices.

The various embodiments of this document and the terms used therein are not intended to limit the technical features described herein to specific embodiments, and should be understood to include various changes, equivalents, or substitutes of the corresponding embodiments. For example, a component expressed in the singular should be understood as including a plurality of components unless the context clearly indicates only the singular. The term "and/or" used in this document should be understood to encompass any and all possible combinations by one or more of the listed items. Terms such as "include," "have," and "be configured" used in the present disclosure are intended only to specify the presence of the features, components, parts, or combinations thereof described herein, and use of such terms is not intended to exclude the presence or addition of one or more other features, components, parts, or combinations thereof. In this document, phrases such as "A or B," "at least one of A and B," "at least one of A or B," "A, B, or C," "at least one of A, B, and C," and "at least one of A, B, or C" may each include any one of the items listed together in the corresponding phrase or all possible combinations thereof. Terms such as "first," "second," "firstly," and "secondly" may be used merely to distinguish the corresponding component from another corresponding component and do not limit the corresponding components in another respect such as importance or order.

In various embodiments of this document, a term such as "unit" or "module" may include a unit implemented in hardware, software, or firmware, and may be used interchangeably with terms such as logic, logic block, part, or circuit. A unit or module may be an integrally configured part or a minimum unit or part thereof that performs one or more functions. For example, according to one embodiment, a unit or module may be implemented in the form of an application-specific integrated circuit (ASIC).

In various embodiments of this document, an expression such as "when" or "in the case that" may be interpreted, depending on context, as "at the time of," "upon," "in response to determining," or "in response to detecting." Similarly, an expression such as "when it is determined" or "when it is detected" may be interpreted, depending on context, as "upon determination," "in response to determining," "upon detection," or "in response to detecting."

A program executed by the server device 200 described throughout this document may be implemented by hardware components, software components, and/or a combination of hardware components and software components. The program may be executed by any system capable of performing computer-readable instructions.

Software may include a computer program, code, instructions, or one or more combinations thereof, and may configure a processing device to operate as desired or may independently or collectively instruct the processing device. The software may be implemented as a computer program including instructions stored in computer-readable storage media. Examples of computer-readable storage media include magnetic storage media such as ROM, RAM, floppy disks, and hard disks, and optically readable media such as CD-ROM and digital versatile disks (DVDs). Computer-readable storage media may be distributed across network-connected computer systems, so that computer-readable code is stored and executed in a distributed manner. A computer program may be distributed online, for example downloaded or uploaded, through an application store such as Play Store ^{TM} or directly between two user devices such as smartphones. In the case of online distribution, at least a portion of a computer program product may be at least temporarily stored or temporarily generated in a device-readable storage medium such as a memory of a manufacturer server, an application-store server, or a relay server.

According to various embodiments, each component of the above-described components, such as a module or program, may include a single entity or a plurality of entities, and some of the plurality of entities may be separately disposed in another component. According to various embodiments, one or more of the above-described components or operations may be omitted, or one or more other components or operations may be added. Alternatively or additionally, a plurality of components, such as modules or programs, may be integrated into one component. In this case, the integrated component may perform one or more functions of each of the plurality of components in the same or similar manner as performed by the corresponding component among the plurality of components before integration. According to various embodiments, operations performed by a module, program, or other component may be executed sequentially, in parallel, repeatedly, or heuristically, or one or more of the operations may be executed in a different order, omitted, or one or more other operations may be added.

What is claimed is:

1. An unmanned forklift device for transporting a heavy load, comprising:
a body including a vehicle-body frame;
a fork disposed in front of the body and configured to support a heavy load;
a lift module configured to raise and lower the fork;
a fork movement module configured to move the fork between a front working position of the body and an upper portion of the body or a stowed position of the body; and
a controller configured to control the lift module and the fork movement module,
wherein the controller is configured to move the fork to the stowed position while the fork is raised to or above a predetermined height, thereby reducing a forward protrusion length of the fork from the body.

2. The unmanned forklift device of claim 1, wherein the fork movement module includes a linear guide disposed between a fork carriage and the vehicle-body frame, and a movement actuator configured to move the fork in a front-rear direction of the body.

3. The unmanned forklift device of claim 1, wherein the controller is configured to operate the fork movement module only when the fork has been raised to or above a preset target height.

4. The unmanned forklift device of claim 1, wherein the controller is configured to move the fork to the stowed position only when a loading state of the fork or a center of gravity of a load carried by the fork satisfies a preset condition.

5. The unmanned forklift device of claim 1, further comprising a locking mechanism configured to fix the fork so that the fork remains disposed in the stowed position.

6. The unmanned forklift device of claim 1, wherein the controller is configured to activate a narrow-space driving mode while the fork is disposed in the stowed position, and wherein the unmanned forklift device is configured to have outer dimensions that allow the unmanned forklift device to be loaded into a cargo hoist or other lifting equipment.

7. An unmanned forklift device comprising:
a body;
a plurality of driving wheels disposed on the body;
a plurality of travel motors configured to respectively provide driving force to the plurality of driving wheels;
a mechanical steering mechanism configured to change a steering angle of at least some of the plurality of driving wheels; and
a controller configured to control the plurality of travel motors and the mechanical steering mechanism,
wherein the controller is configured to selectively perform at least one of a first steering mode using the mechanical steering mechanism, a second steering mode using differential control of the plurality of travel motors, and a third steering mode in which the first steering mode and the second steering mode are performed together.

8. The unmanned forklift device of claim 7, wherein the mechanical steering mechanism includes a pair of knuckles respectively coupled to a pair of steering wheels among the plurality of driving wheels, a tie rod connecting the pair of knuckles, and a steering actuator configured to displace the tie rod.

9. The unmanned forklift device of claim 8, wherein the mechanical steering mechanism is configured so that, during turning, a steering angle of an inner steering wheel of the pair of steering wheels is greater than a steering angle of an outer steering wheel of the pair of steering wheels.

10. The unmanned forklift device of claim 7, wherein, in the second steering mode, the controller is configured to turn the body by controlling a rotation speed or a rotation direction of a left driving-wheel group and a right driving-wheel group differently from each other, the left driving-wheel group and the right driving-wheel group each including at least one of the plurality of driving wheels.

11. The unmanned forklift device of claim 7, wherein, in the third steering mode, the controller is configured to simultaneously perform steering by the mechanical steering mechanism and differential control of the plurality of travel motors, thereby implementing a turning radius smaller than when the first steering mode alone is performed.

12. The unmanned forklift device of claim 7, wherein the controller is configured to select one of the first steering mode, the second steering mode, and the third steering mode based on at least one of driving speed, loaded weight, path curvature, obstacle information, and surrounding-environment information.

13. The unmanned forklift device of claim 12, wherein the controller is configured to preferentially select the first steering mode when at least one of the driving speed exceeds a preset speed threshold or the loaded weight exceeds a preset load threshold.

14. The unmanned forklift device of claim 12, wherein the controller is configured to select the third steering mode when the path curvature or a target turning radius is equal to or smaller than a preset reference value, and to switch to the second steering mode and perform a pivot turn or a sharp turn when a separation distance from an obstacle is equal to or smaller than a preset proximity threshold.

15. The unmanned forklift device of claim 12, wherein the controller is configured to perform ramping control or hysteresis control so that a control amount changes gradually when the steering mode is switched.

16. The unmanned forklift device of claim 7, wherein the plurality of driving wheels includes a pair of front wheels respectively disposed on left and right sides of a front of the body and a pair of rear wheels respectively disposed on left and right sides of a rear of the body.

17. The unmanned forklift device of claim 16, wherein the mechanical steering mechanism is a rear-wheel steering mechanism connected to the rear wheels.

18. The unmanned forklift device of claim 1 or 7, further comprising:
an attitude sensor configured to detect an inclination of the body; and
a tilting module configured to adjust an inclination of a mast or a fork support of the unmanned forklift device,
wherein the controller is configured to correct the inclination of the mast or the fork support based on inclination information obtained from the attitude sensor.

19. A method of operating an unmanned forklift for transporting a heavy load, the method comprising:
confirming whether a load is loaded on a fork;
raising or lowering the fork;
moving the fork from a front working position of a vehicle body of the unmanned forklift to an upper portion of the vehicle body or a stowed position of the vehicle body;
traveling while the fork is disposed in the stowed position; and
at a destination, returning the fork forward and unloading the load.

20. The method of claim 19, wherein the traveling comprises selecting one of mechanical steering, differential-drive steering, and composite steering based on at least one of driving speed, loaded weight, path curvature, obstacle information, and surrounding-environment information, and wherein the method further comprises, based on the obstacle information, performing a pivot turn or a sharp turn when a separation distance from an obstacle is equal to or smaller than a preset reference value.
